(19) United States
(12) Patent Application Publication
(10) Pub. No.: US 2009/0217234 A1
(43) Pub. Date: Aug. 27, 2009

(54) Object-Oriented Meetings Flow Modelling Method for Software Development Management

(75) Inventor: Chung-Yang Chen, Kwei-Shan (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Kwei-Shan (TW)

(21) Appl. No.: 12/392,595

(22) Filed: Feb. 25, 2009

Related U.S. Application Data
(63) Continuation-in-part of application No. 11/160,075, filed on Jun. 8, 2005, now abandoned.

(51) Int. Cl. G06F 9/44

(52) U.S. Cl. 717/101

(57) ABSTRACT

An object-oriented meetings flow modeling method, with the aid of object oriented analysis or design technique, for software development management includes establishing or identifying WBS of a project; identifying a plurality of work items that require a group action; identifying a plurality of critical products or deliverables that require a group function; encapsulating and typifying the group function into a meeting class; planning relevant stakeholders for the meeting class; establishing a temporal meeting flow based on a corresponding position of the meeting class on the WBS; establishing a contextual meeting flow; obtaining commitment from the relevant stakeholders for execution; identifying surrogates with authorization; and saving the temporal meeting flow and the contextual meeting flow as a meeting flow template for future use.

### CROSS REFERENCE TO RELATED PATENT APPLICATION

This patent application is a continuation-in-part (CIP) application of a U.S. patent application Ser. No. 11/160,075 filed Jun. 8, 2005. The contents of the related patent application are incorporated herein for reference.

### BACKGROUND OF THE INVENTION

1. Field of the Invention

The invention relates generally to an object-oriented meetings flow modeling method for software development management, and more particularly to an improved model which utilizes object-oriented technology to manage a software project by managing a project's functional meetings, and work out the flow charts and data flow diagrams by modeling the sequence and contexts among meetings.

2. Description of Related Art

Software project development (SPM) heavily relies on group effort to accomplish ad-hoc work items. Therefore, software project management should not only be for project manager's job, but for all relevant stakeholders. In this context, SPM should provide a way as well as a venue for relevant stakeholders to realize their joint effort during the development and to continuously monitor the development.

At present, many of project management tools are commercially available, e.g., Project Console from Rational product suite, MS Project, WindChill, Primavera, Timeline, Work Bench, Project Scheduler, Agile, etc. These tools offer procedure oriented WBS (work breakdown structure) and related schedule control capability by establishing checkpoints and milestones for a software project. Yet, these conventional methods or tools are mainly for project managers only and are focused on discrete timing, budgeting and resource planning, which belong to sectional or one-sided management. In other words: (1) the implementation plans do not provide a collective view for focusing on group action and function and are inaccessible or only accessible to a few people, and (2) the progress and problems can only be identified by milestones and checkpoints, which may not be sufficient and timely enough because by the time such fragmented monitoring identifies a quality problem, it may be too late for the problem to be fixed. Though some project management tools allow for key personnel of different authorities to access the project outputs over the Internet (e.g., Project Console in Rational Suite), it is difficult to prevent gross negligence, especially when the project managers cannot supervise the detailed progress.

In activities, including software project development, meetings have been widely used as a venue to handle group communication and institutionalize people participation. Speaking of meetings, existing meeting studies mostly refer to the micro level of meeting practice, i.e., the effectiveness and efficiency of running a single meeting or a group action. Existing meeting management tools are mostly for planning meetings individually, or the utilization of information technologies to overcome the geographical constraints then facilitate and promote a remote meeting execution environment.

In project management, in addition to having milestones and checkpoints, a mechanism, as well as a sustained venue, is needed to help stakeholders better know the current project status and thus can provide timely support throughout the development of a software project. Seeing the current usage of meetings, they should be better utilized and further be incorporated into project development processes in continuously realizing timely information dissemination and promoting the cooperative situation.

To this end, existing project management tools or meeting studies and tools lack of a method that focuses on the macro perspective of project meetings and then innovatively to establish the “connection” of these meetings to form a meeting-oriented integrated group process (i.e., meetings flow) for stakeholders to join in the development for sustainable management and monitoring of project development process. Thus, improvement still exists.

### SUMMARY OF THE INVENTION

It is therefore an object of the invention to provide an object-oriented meetings flow modeling method, with the aid of object oriented analysis or design technique, that takes advantages of meetings and incorporates them into a development process to form an integrated macro group-process for software project management.

### BRIEF DESCRIPTION OF THE DRAWINGS

FIG. 1 is a schematic drawing of meeting types of the invention in which an abstract meeting type Meeting is formed, a Project-Level Functional Meeting is a sub-type specialized from the Meeting, and there are five behavioral types of functional project meetings;

FIG. 2 is a schematic drawing of project development life cycle depicted by meetings flow which refers to the integrated macro group-process;

FIG. 3 is a process including nine steps for establishing meetings flow of a software project according to the invention;

FIG. 4 depicts the contextual relationship and temporal relationship among meeting entities/classes; and

FIG. 5 is a temporal flow and a contextual meetings flow constructed according to the invention.

### DETAILED DESCRIPTION OF THE INVENTION

The invention is directed to an object-oriented meetings flow modeling method for software development management, which, with the aid of an object-oriented analysis or design method, depicts a meetings framework by defining meeting types, meeting behaviors, meeting state, the flow of meetings, and the steps for constructing meetings flow. The invention includes three parts as described below:

### 1. Definition of Meeting Types and Behaviors

The definition of meeting operating modes required for project development comprises the following three elements:

### (a) Defining Meeting's Abstract Data Type (ADT)

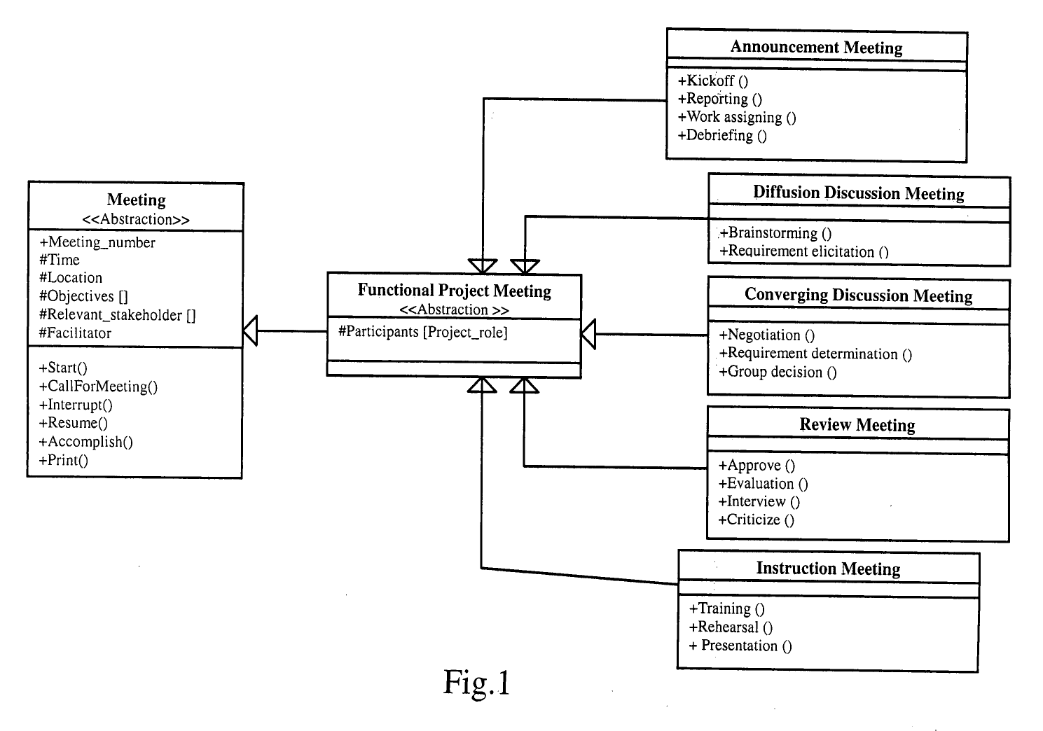

Firstly, define the super type of meetings based on object-oriented technology. A meeting super type defines properties and behaviors that are common in all meetings. Sub meeting types are derived from that super type due to specialized needs. FIG. 1 shows the inheritance hierarchy of these meeting types and behaviors with two ADTs: (1) the root class (Meeting) for all meetings and (2) the derived Project Functional Meeting that is specialized for software project development meetings.

### (b) Modeling the States of a Meeting

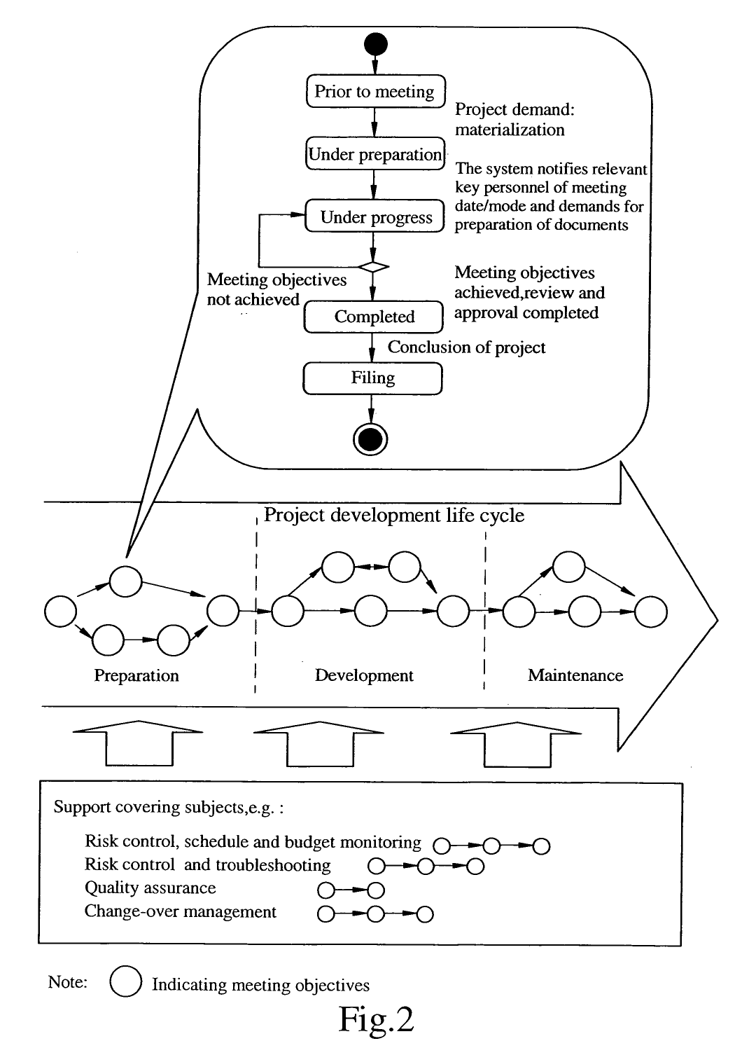

Objects have states, and so do meeting objects. The invention models the states (as shown in the upper part of FIG. 2) of meeting objects according to their lifecycle. For example, the states of meetings are available with “prior to convention”, “under preparation”, “under progress” or “required repetitive under progress” if meeting objectives are not met, and finally “accomplished” state. The meetings of the invention are characterized that the overall project progress can be indicated through the states of the meeting objects on the main flow and time marks, rather than through sectional checkpoints.

### (c) Modeling Functional Meetings in Project Development

Moreover, after identifying basic hierarchy meeting type for a software project, the invention further models the behavioral types of meetings. These behavioral types are derived from the project functional meeting class ADT. They also define relevant operations specific to meetings of the same type.

The five common behavioral types are (1) Announcement, (2) Diffusion discussion, (3) Converging discussion, (4) Review, and (5) Instruction and demonstration.

FIG. 1 shows the definition of the meeting types and the behavioral sub-types using UML class diagram according to the invention.

A meeting entity (or called meeting object) may have multiple inheritances from these behavioral types. For example, a project feasibility analysis meeting (coded FEA) may involve (1) evaluating (or called reviewing) the collected information and possible technical solutions regarding the new project, (2) discussing and determining (or called converging) the desired solution. Then this FEA inherits both the Review and Converging Discussion behavior (see FIG. 1).

These meeting ADT and the behavioral types are useful for project members to carefully identify and select proper meeting types and assign proper project roles to participate in meetings according to the expected property and behavior of the group action inside a meeting.

In a teamwork-based, multi-party development environment like software project, people involvement plays a critical role. Assigning proper project roles to a meeting class would ensure and sustain (when the meeting is recalled) the quality of execution of instances of the meeting class. According to the invention once functional meeting classes are identified, a holistic stipulation of involvement/participation for stakeholder roles or parties in these meetings is also planned. By doing so, the project can have a holistic view on stakeholder assignments in all expected functional meetings and then can monitor their involvement by checking the actual attendance.

### 2. Integrated Macro Group-Process Model Identified by Meetings

By using object-oriented aggregation concept based on features and requirements of meetings, meeting objects are selectively aggregated into four operational categories in software development lifecycle of the invention. The four categories are: (1) project preparation (in marketing field it is called presale), (2) development, (3) maintenance, and (4) support. See FIG. 2 for the illustration of the four categories and the aggregation of meetings in these four categories.

Other features of meetings according to the invention are that meetings are further linked up to form meetings flow. Two types of meetings flow are introduced: (1) temporal meetings flow, and (2) contextual meetings flow. These two flow types and their function are described as follows.

### (a) Temporal Meetings Flow

Meetings are linked up according to their sequence of scheduled occurrence. For example, meeting A is scheduled prior to meeting B, which is scheduled prior to meeting C. Then meetings A, B, and C form a temporal meeting flow. FIG. 1 is the presentation of temporal meetings flow.

The temporal meetings flow can act as an integrated process that depicts how a software project proceeds in terms of group actions (that is, meetings). Such an integrated process also refers to meeting-oriented group process, or macro group-process of a software project according to the invention.

Such temporal meetings flow has three functions: (1) the state of each meeting entity on the flow indicates the dynamic progress of the software project; (2) such a flow forms an institutionalized venue for stakeholders to join in the development process, and (3) such a flow forms a continuous channel where not only project controllers, but also all relevant stakeholders can monitor the development and communication, thus achieving in the realm of getting right information to the right people via the right venue (meeting).

### (b) Contextual Meetings Flow

In traditional meeting practice, local and current issues may overwhelm the preplanned items on the meeting agenda, and even those preplanned items may concern with only the most recent meetings. In other words, a traditional “well-planned and tracked” (i.e., Through follow-up checks and to-do lists) meetings only has a narrow scope of control (i.e., The previous and the next immediate meetings), resulting in micromanagement of meetings.

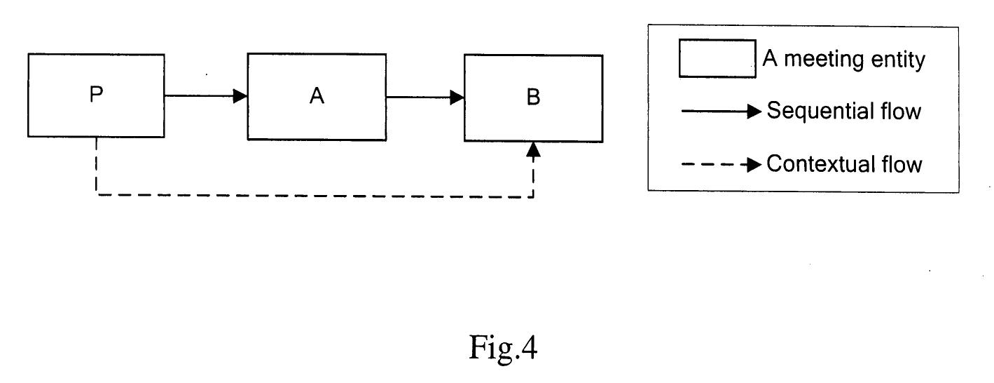

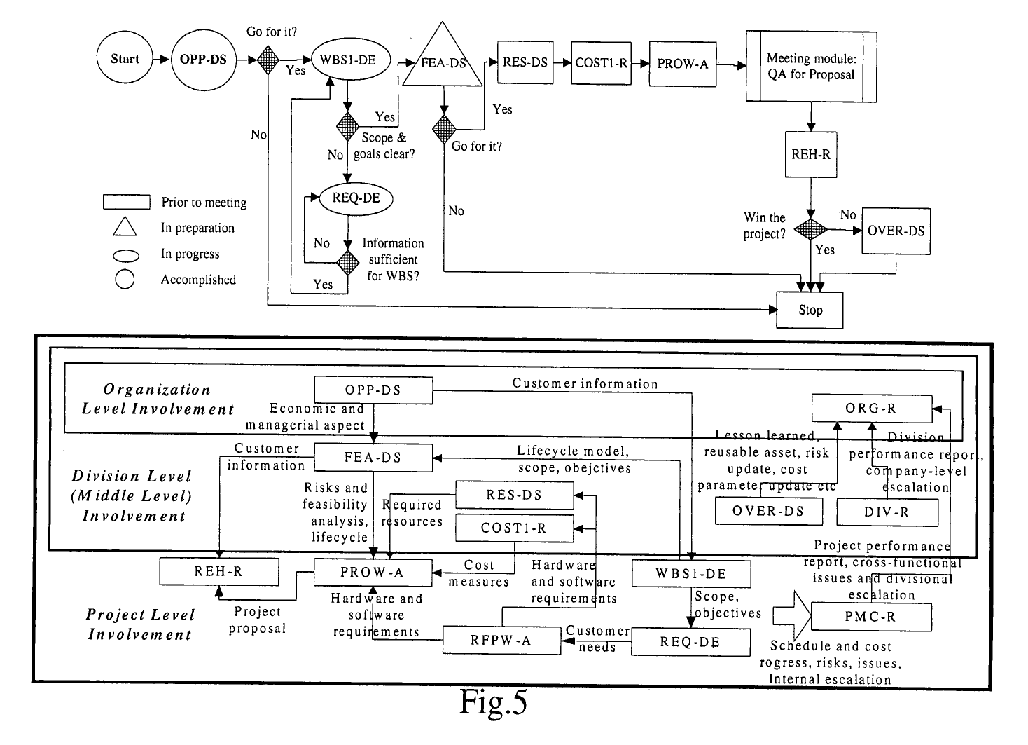

To address this issue, the invention envisages that meetings further establish mutual contextual relationships. Thus, in addition to the temporal sequence of these meetings; the term meetings flow also refers to the inter-meeting dependency as well. As shown in FIG. 4, scheduling meeting entity B, for example, after the completion of meeting entity A, which is after the completion of entity P, is the sequence of the meetings. Inter-meeting dependency refers to that, for example, B depends on A because B needs the conclusions of A. Note that these conclusions could be the information or documents produced or verified in A; and this inter-meeting dependency may include (1) B also needs information from previous meetings (Meeting P in the FIG. 4, and (2) while in P, participants know that the meeting's conclusions will be used in B which does not immediately follow P. For a complete example and illustration, see FIG. 5.

The contextual meetings flow is established in order for stakeholders to have a holistic and long-term planning insight of all expected meetings in the project lifecycle. In other words, such a big picture allows relevant stakeholders and participating groups to understand the relationship and linkage between their involvement to the project, and that their own efforts in local meetings do contribute to the global accomplishment.

### 3. Steps for Constructing Meetings Flow Model

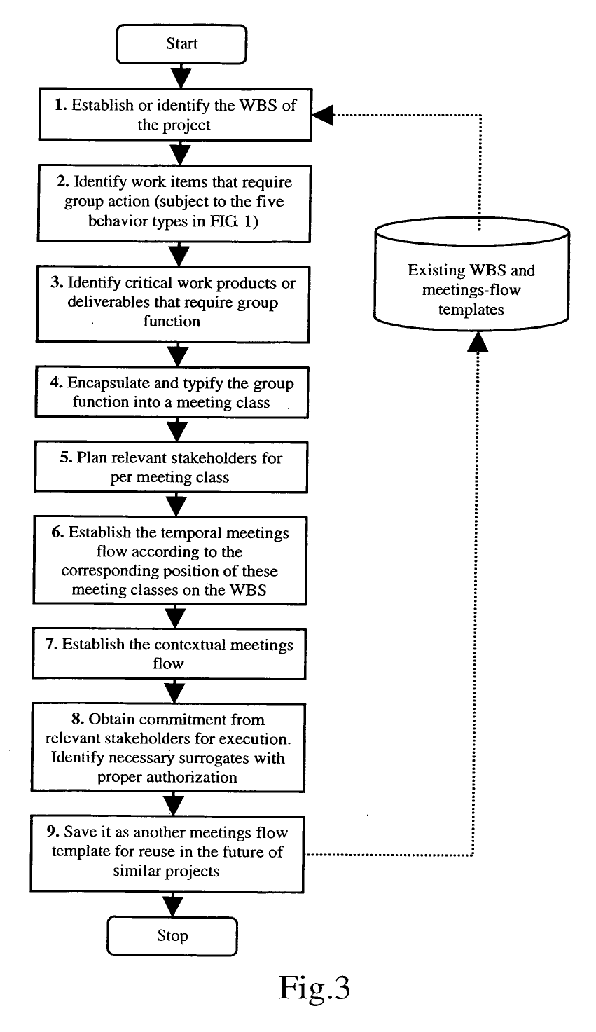

The invention provides a process to construct meetings flow. The process comprises nine steps as shown in FIG. 3.

To identify meeting classes, the invention starts with the procedure oriented WBS (work breakdown structure) of a software project. In this invention, meeting classes are identified by two sources: (1) the work items on the WBS that requires group action; and (2) the critical work products or deliverables that require group function in producing or supporting the work products. On the WBS, the work items that require group action (subject to the five behavior types in FIG. 1) are identified. For example, on the WBS the work item: “Elicit Customer Needs” requires group action for both developers and users to discuss suitable requirements. Therefore, a meeting Requirement Exploration Meeting (coded REQ-DE) is defined to serve and encapsulate this group action.

Meeting classes can also be identified according to critical work products and deliverables. For example, a critical work product, the project plan, may require group action and function to assign the writing job for producing the document, and then review the quality when the document is finished. These two group actions are then encapsulated into two meeting classes/entities: Project Plan Writhing Assigning Meeting and Review of Project Plan Meeting.

To exactly denote work items for planning the WBS and for identifying possible meetings, one can refer the recommended practices of software development in CMMI. CMMI, a what-to-do reference model for software project development, identifies a number of building blocks (as Process Areas, PA) in software development and further suggests best practices (as: Specific Practices, SP) for each building block. For example, in the requirement development process area, specific practices are: Elicit Needs, Develop the Customer Requirements, Establish Product and Product Component Requirements, Allocate Product Component Requirements, Identify Interface Requirements, etc. Thus the procedure oriented WBS of a software project can refer to a collection, combination and arrangement of the specific practices in the process areas of CMMI. Then, group actions can be further identified according to the procedure oriented WBS, which specifically refers to the SPs in CMMI.

Once expected meeting classes are identified, participants for all the meetings are planned in order to yield an institutionalized effect on the execution of these meetings. Meeting participants refer to relevant stakeholders who should prepare the meeting, convene the meeting, attend the meeting, receive meeting results, or approve the meeting results. Although micro-level issues such as facilitating and administrating services (such as time, place, meeting tool, etc) are also needed for such institutionalization but they are not the subject of the invention.

Once meetings are identified, they are planned in a temporal way. According to the invention the temporal meetings flow is established according to the corresponding position of the meeting classes on the procedure oriented WBS. Meanwhile, commitment from relevant stakeholders for execution and necessary surrogates with proper authorization ought to be obtained.

### 4. Exemplary Example

An exemplary example is provided to illustrate the invention. Table-1 below shows a list of expected functional meetings from the WBS of the preparation phase of a software project (coded CWB) in a software company (AA).

TABLE 1

| Meeting Class | Operation and Explanation |
|---|---|
| Project opportunity discussion | The management and relevant stakeholders discuss the |
| (OPP-DS) | opportunity of a potential project according to RFP or |
| | necessary customer information. SWOT analysis might be |
| | required for the meeting. If the company decides to compete |
| | on the project, a War Team is formed. |
| Functional WBS exploration | The members collect necessary info regarding the customer |
| (WBS1-DE) | and make proposals to the team in this meeting. The |
| | meeting discusses possible functional architecture, which |
| | will become the basis of the proposed technical scope. This |
| | will also be the basis of the WBS in the project proposal or |
| | plan. |
| Project feasibility discussion | A comprehensive aspect of feasibility and related technical |
| (FEA-DS) | solutions are analyzed here. Risks are identified effectively, |
| | and they will be in the risk management sub-plan later on in |
| | PROW-A. |
| Resources scheduling & | Initial resource allocations for the new project are |
| negotiation (RES-DS) | negotiated and scheduled. |
| Cost estimation (COST1-R) | Based on the information from RES-DS and WBS1-DE, the |
| | costs are estimated by experienced peers. Cost-effectiveness |
| | analysis is both performed and reviewed. |
| Proposal writing assigning | In this team meeting the writing of the project proposal is |
| (PROW-A) | designated to relevant stakeholders. |
| Presentation rehearsal and drill | The management and relevant committee walk through the |
| (REH-R) | rehearsal and give feedback. |
| Requirement exploration | Systems analyst(s) perform(s) an onsite visit to ascertain |
| (REQ-DE) | any critical customer needs. |
| RFP writing assigning | In this team meeting the writing of the project proposal is |
| (RFPW-A) | designated to relevant stakeholders. |
| Debriefing & lesson learned | Whether or not a project ends successfully, the company |
| (OVER-DS) | meets to collect and consolidate the experiences and lessons |
| | learned. |
| Project monitor and control | The project manager calls the team in weekly to check on |
| review (PMC-R) | progress. Internal hierarchical escalations are made when |
| | necessary. The team also reviews issues from QA audit and |
| | takes corrective actions. |
| Performance review, division | This meeting reviews project performance at the division |
| (DIV-R) | level. Internal hierarchical escalations are made when |
| | necessary. Some issues are resolved in this meeting. |
| | Meetings are bi-weekly. |
| Performance review, | In this meeting, top management, division leaders, and all |
| organization (ORG-R) | project representatives review project status and resolve |
| | cross-functional issues. When necessary, company-level |
| | escalations are made to resolve the issues. Meets are |
| | monthly. |

At the beginning of the CWB project, an employee from the sales department receives information from CWB regarding a system request. He then reports to the management, and AA starts an OPP-DS to discuss and analyze the potential of this new project opportunity. After they decide to compete on that project, an initial team called a War Team is formed. For the preparation phase, the team first uses a PERT-like CASE tool, as the upper part of FIG. 5 illustrates, to schedule their meetings due to the given time constraint. This refers to the temporal meetings flow.

The company then runs WBS1-DE to collect information, including RFP. This meeting yields a solution proposal and constructs a functional architecture for the contemplated system. The WBS1-DE meeting starts with the project opportunity information (from OPP-DS) and RFP. These information sets are entry criteria for WBS1-DE, which means that the meeting will not be fruitful without them. WBS1-DE ends only when the agenda has been completed and a high-level functional WBS has been developed. Hence, a confirmed WBS that is based on the RFP and SRS is one of the exit criteria for WBS1-DE. To be more competitive, as soon as a functional architecture is developed, the team immediately starts REQ-DE to ensure that the proposed functions really meet the expectation. In other words, REQ-DE may start before the WBS is confirmed and finalized (i.e., ended). So representatives go to customer site to meet users or call them to clear up questions relating to the RFP and SRS. These trips bring in hot news and help to reveal some previously unknown needs. When the team has nearly completed the entire user interviews, it initiates and prepares to run the next meeting (FEA-DS) which will discuss technical feasibility and make decisions on substantive technical solutions.

In parallel, the team has been running PMC-R every week from the start. It gathers all necessary information during regular meetings and makes necessary reports to DIV-R (a bi-weekly division-level review meeting). During the current DIV-R the team reports that REQ-DE has met three times and that one more interview is still needed. The status of all meetings at this time is as follows: OPP-DS is done, QRE-DE is under-progress, FEA-DS is initiated, and the other meetings are yet to be activated.

The upper part of FIG. 5 illustrates the physical flow of the meeting classes, and thus also the integrated macro group-process which indicate the joint effort throughout the project. It is also used as a graphical progress indicator to provide the abovementioned information and as a more continuous way for relevant stakeholders to monitor the project.

As shown in the lower part of FIG. 5, AA used a simple DFD (Data Flow Diagram)-like diagramming tool to frame the information and knowledge context for the planned meeting classes. This also refers to the contextual representation of the meetings flow. In this case, such representation has two purposes. The first purpose is to show the data/information/documents that a meeting (including necessary post-meeting actions) that it is supposed to produce and acquire, related to the entire project. With access to the big picture, the project team clearly knows why they should have a particular project meeting and what they should do inside that meeting from the global viewpoint, as the picture shows the role the meeting plays in relation to the entire project.

The second purpose is to show the involvement of all business levels participating in meetings for a software project, and to preserve and allocate these involvements to the relevant meetings. Typically, in software project management, attention has often been put solely on the work performed by a project team or at the project level. In fact, the endeavor required for a software project exists at all levels of management, especially in communicating the shared vision and the valuation of a project. In this case we observe project meeting flows at not only project level but also other levels, and identify the participation from the rest of the organization in order to integrate the frontline operations, general management, and socio-technical views for a software project.

In brief, the invention is contemplated to promote overall economic efficiency by its many functions and actual value.

While the invention herein disclosed has been described by means of specific embodiments, numerous modifications could be made thereto by those skilled in the art without departing from the scope and spirit of the invention set forth in the claims.

What is claimed is:

1. An object-oriented meetings flow modeling method for software development management comprising the steps of:
establishing or identifying procedure oriented WBS (work breakdown structure) of a project;
identifying a plurality of work items that require a group action;
identifying a plurality of critical products or deliverables that require a group function in producing (such as writing assigning) and supporting (such as review, evaluation, approval) the work products;
encapsulating and typifying the group function into a meeting class;
planning relevant stakeholders for the meeting class;
establishing a temporal meeting flow based on a corresponding position of the meeting class on the WBS;
establishing a contextual meeting flow;
obtaining commitment from the relevant stakeholders for execution;
identifying surrogates with authorization; and
saving the temporal meeting flow and the contextual meeting flow as a meeting flow template for future use.

2. The object-oriented meetings flow modeling method of claim 1, wherein:
the procedure oriented WBS in the first step, to be operationally specific, can refer to a collection, combination and arrangement of the specific practices in the process areas of CMMI, and it (the WBS) can be carried out by existing project management and planning tools;
the group actions of project work items in the second step can specifically refer to the specific practices in CMMI which require group action, such as presentation rehearsal, kickoff, feasibility analysis, requirement elicitation, monitoring and reporting, peer review, change approval, job assigning, and post project review;
the critical work products and deliverables in the third step can specifically refer to typical work products of the specific practices in CMMI, such as project proposal, project plan, systems analysis document, systems design and specification document, user manual, training materials;
the behavior types of group action and function specifically refer to (1) announcement, (2) diffusion discussion, (3) converging discussion, (4) review, and (5) instruction and demonstration;
the relevant stakeholders in the fifth step specifically refer to personnel who should prepare the meeting, convene the meeting, attend the meeting, receive meeting results, and approve the meeting results.

3. The object-oriented meetings flow modeling method of claim 1, wherein the temporal meeting flow and the contextual meeting flow together are adapted to represent an integrated macro group-process for macro-management of a plurality of group event, actions, or quality deliverables in a software project.
